(19) United States
(12) Patent Application Publication
(10) Pub. No.: US 2009/0204758 A1
(43) Pub. Date: Aug. 13, 2009

(54) SYSTEMS AND METHODS FOR ASYMMETRIC RAID DEVICES

(75) Inventor: Stephen G. Luning, Austin, TX (US)

Correspondence Address: LARSON NEWMAN ABEL & POLANSKY, LLP, 5914 WEST COURTYARD DRIVE, SUITE 200, AUSTIN, TX, 78730, US

(73) Assignee: DELL PRODUCTS, LP, Round Rock, TX (US)

(21) Appl. No.: 12/030,391

(22) Filed: Feb. 13, 2008

(51) Int. Cl. G06F 12/00

(52) U.S. Cl. 711/114; 711/E12.001

(57) ABSTRACT

An information handling system can include an asymmetric RAID device. The information handling system comprises a RAID controller and a RAID volume. The RAID volume includes a first disk and a second disk attached to the RAID controller, wherein the first disk provides faster access than the second disk. In a particular embodiment, the first disk is an SSD and the second disk is a HDD. The RAID controller may be configured to support symmetric or asymmetric write operations.

### FIELD OF THE DISCLOSURE

This disclosure relates generally to information handling systems, and more particularly to systems and methods for asymmetric Redundant Array of Independent Disks (RAID) devices.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 illustrates a block diagram of an information handling system according to one aspect of the disclosure;

FIG. 2 is a block diagram of a symmetric RAID device;

FIG. 3 is a flow diagram of a write and a read operation in an asymmetric RAID device; and

FIG. 4 is a flow diagram for an asymmetric write operation in an asymmetric RAID device.

The use of the same reference symbols in different drawings indicates similar or identical items.

### DETAILED DESCRIPTION OF DRAWINGS

As indicated above, the following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. For example, much of the following focuses on information handling systems having printed circuit boards with quality verification test structures and methods for testing test structures. However, other techniques may be utilized in connection with the teachings of this application. For example, the teachings may also be utilized in applications and with several different types of architectures such as distributed computing architectures, client/server architectures, middleware server architectures, and other appropriate systems and/or architectures.

For purposes of this disclosure, an information handling system may include an instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communications between the various hardware components.

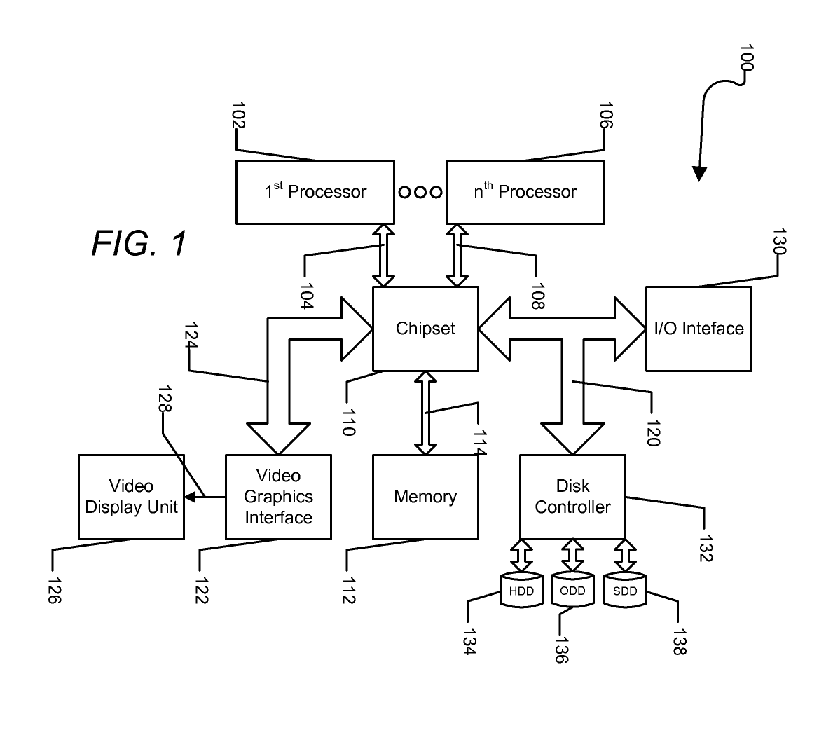

FIG. 1 illustrates a block diagram of an exemplary embodiment of an information handling system, generally designated at 100. In one form, the information handling system 100 can be a computer system such as a server. As shown in FIG. 1, the information handling system 100 can include a physical processor 102 coupled to a host bus 104 and can further include additional processors generally designated as an n^{th} physical processor 106 coupled to a n^{th} host bus 108. The physical processor 102 can be coupled to a chipset 110 via the host bus 104. Further, the n^{th} physical processor 106 can be coupled to the chipset 110 via the n^{th} host bus 108. The chipset 110 can support multiple processors and can allow for simultaneous processing of multiple processors and support the exchange of information within the information handling system 100 during multiple processing operations.

According to one aspect, the chipset 110 can be referred to as a memory hub or a memory controller. For example, the chipset 110 can include an Accelerated Hub Architecture (AHA) that uses a dedicated bus to transfer data between first physical processor 102 and the n^{th} physical processor 106. For example, the chipset 110, including an AHA enabled-chipset, can include a memory controller hub and an input/output (I/O) controller hub. As a memory controller hub, the chipset 110 can function to provide access to the physical processor 102 using the host bus 104 and the n^{th} physical processor 106 using the n^{th} host bus 108. The chipset 110 can also provide a memory interface for accessing memory 112 using a memory bus 114. In a particular embodiment, the buses 104, 108, and 114 can be individual buses or part of the same bus. The chipset 110 may also provide bus control and may handle transfers among the buses 104, 108, and 114.

According to another aspect, the chipset 110 may be an application specific chipset that provides connectivity to various buses, and integrates other system functions. For example, the chipset 110 can be provided using an Intel® Hub Architecture (IHA) chipset that can also include two parts, a Graphics and AGP Memory Controller Hub (GMCH) and an I/O Controller Hub (ICH). For example, an Intel 820E chipset, an 815E chipset, or any combination thereof, available from the Intel Corporation of Santa Clara, Calif., can provide at least a portion of the chipset 110. The chipset 110 can also be packaged as an application specific integrated circuit (ASIC).

The information handling system 100 can also include a video graphics interface 122 that can be coupled to the chipset 110 using a third host bus 124. In one form, the video graphics interface 122 can be an Accelerated Graphics Port (AGP) interface to display content within a video display unit 126. Other graphics interfaces may also be used. The video graphics interface 122 can provide a video display output 128 to the video display unit 126. The video display unit 126 can include one or more types of video displays such as a flat panel display (FPD) or other type of display device.

The information handling system 100 can also include an I/O interface 130 that can be connected via an I/O bus 120 to the chipset 110. The I/O interface 130 and I/O bus 120 can include industry standard buses or proprietary buses and respective interfaces or controllers. For example, the I/O bus 120 can also include a Peripheral Component Interconnect (PCI) bus or a high speed PCI-Express bus. In one embodiment, a PCI bus can be operated at approximately 66 MHz and a PCI-Express bus can be operated at approximately 128 Mhz. PCI buses and PCI-Express buses can be provided to comply with industry standards for connecting and communicating between various PCI-enabled hardware devices. Other buses can also be provided in association with, or independent of, the I/O bus 120 including, but not limited to, industry standard buses or proprietary buses, such as Industry Standard Architecture (ISA), Small Computer Serial Interface (SCSI), Inter-Integrated Circuit (I²C), System Packet Interface (SPI), or Universal Serial buses (USBs).

In an alternate embodiment, the chipset 110 can be a chipset employing a Northbridge/Southbridge chipset configuration (not illustrated). For example, a Northbridge portion of the chipset 110 can communicate with the first physical processor 102 and can control interaction with the memory 112, the I/O bus 120 that can be operable as a PCI bus, and activities for the video graphics interface 122. The Northbridge portion can also communicate with the physical processor 102 using the host bus 104 and the n^{th} host bus 108 coupled to the n^{th} physical processor 106. The chipset 110 can also include a Southbridge portion (not illustrated) of the chipset 110 and can handle I/O functions of the chipset 110. The Southbridge portion can manage the basic forms of I/O such as Universal Serial Bus (USB), serial I/O, audio outputs, Integrated Drive Electronics (IDE), and ISA I/O for the information handling system 100.

The information handling system 100 can further include a disk controller 132 coupled to the I/O bus 120, and connecting one or more internal disk drives such as a hard disk drive (HDD) 134, an optical disk drive (ODD) 136, and a solid-state storage device (SSD) 138. The ODD 136 can include a Read/Write Compact Disk (R/W CD), a Read/Write Digital Video Disk (R/W DVD), a Read/Write mini-Digital Video Disk (R/W mini-DVD), or other type of optical disk drive. The SSD 138 can include a drive having no internal movable parts, such as a flash drive.

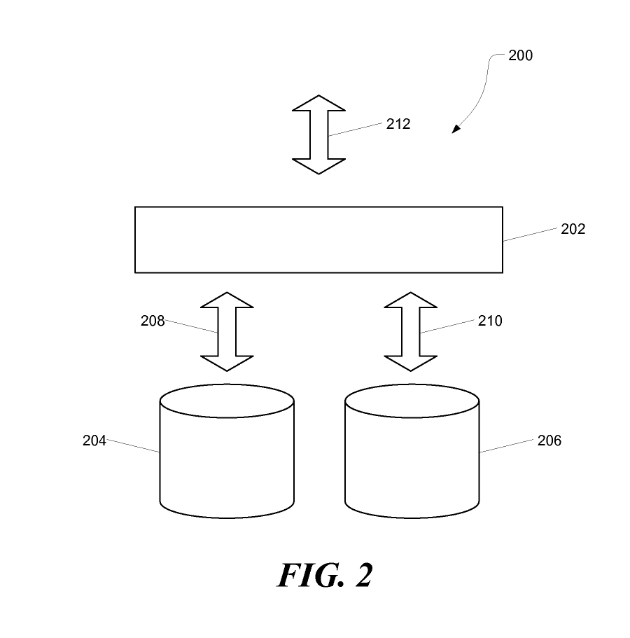

FIG. 2 illustrates a RAID device 200, including RAID controller 202 and storage volumes 204 and 206. RAID controller 202 can be implemented in hardware, software, or any combination thereof. Storage volume 204 communicates with the RAID controller 202 through disk I/O 208, and storage volume 206 communicates with the RAID controller 202 through disk I/O 210. Examples of disk I/O 208 and 210 can include Advanced Technology Attachment (ATA) interface, Serial Advanced Technology Attachment (SATA) interface, and Small Computer System Interface (SCSI). The RAID controller 202 can communicate with the host system through I/O bus 212, such as SCSI, Peripheral Component Interconnect (PCI), Fibre Channel, IEEE 1394 (Firewire), or Universal Serial Bus (USB).

Utilizing RAID 0, the RAID device can improve performance by striping data across storage volumes 204 and 206. That is, a first block of data can be written to storage volume 204 and a second block of data can be written to storage volume 206. As storage volume 204 and storage volume 206 can be read from or written to simultaneously, read/write performance can be improved. Utilizing RAID 1, the RAID device 200 can increase fault tolerance by mirroring storage volume 204 to storage volume 206. That is, substantially identical data can be stored on both storage volume 204 and storage volume 206. In the event of a failure of either of storage volume 204 or storage volume 206, the data can be recovered from the remaining storage volume 206 or storage volume 204 respectively.

In an exemplary embodiment, the RAID device 200 can be a symmetric RAID device. That is, storage volumes 204 and 206 can be similar, such as two HDDs or two SSDs. Generally, HDD storage can be cheaper and have a higher capacity than SSD storage. However, SSD storage can be faster for read/write operations. Additional embodiments can utilize storage volumes spanning multiple physical devices, such as RAID 0 arrays.

In an alternate embodiment, the RAID device 200 can be an asymmetric RAID device, such that storage volume 204 can be a faster storage and storage volume 206 can be a slower storage. For example, storage volume 204 can include solid state media, such as an SSD an array of SSDs, and storage volume 206 can include movable storage, such as a HDD, or an array of HDDs. Generally, reading from and writing to solid state media is faster than reading from and writing to a movable media. Specifically, movable media, such as a tape or a HDD requires movement of the read/write head and/or the recording medium to position the read/write head for accessing or writing the stored data. In contrast, data on the solid-state media can be accessed directly, avoiding the seek delay. However, writing to an SSD may require erasing a block of memory prior to writing the data. When writing small amounts of data, writing the data to an HDD may be faster than writing to an SSD. Preferably, an asymmetric RAID device implements a RAID 1 array, as the benefit of striping is substantially diminished due to the significant differences in the read/write speeds of storage volume 204 and storage volume 206.

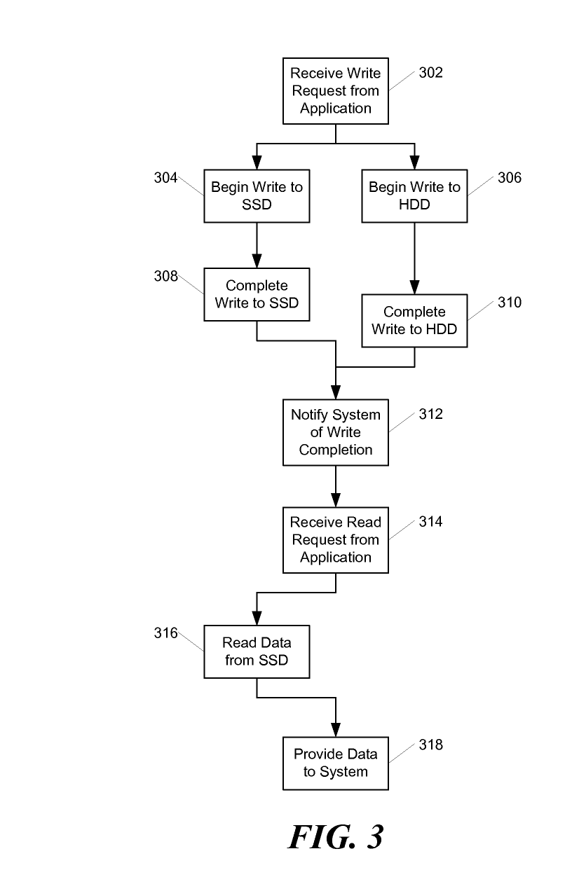

FIG. 3 shows an exemplary embodiment of a method for writing to and reading from an asymmetric RAID device, such as RAID device 200. During a write operation the RAID device can write data to both an SSD storage and a HDD storage, to provide data redundancy. During a read operation, the RAID device can read data from the SSD storage to provide a faster response time than is capable from the HDD storage. At 302, the RAID controller can receive a write request from a system. The write request can include data to be written to the RAID device. At 304, the RAID controller can begin writing the data to the SSD storage. Substantially simultaneous to beginning to write the data to the SSD storage at 304, the RAID control can begin to write data to the HDD storage, as shown at 306. As writing to the HDD storage can be slower than writing to the SSD storage, writing the data to the SSD storage can complete at 308 prior to completion of writing the data to the HDD storage at 310. Alternatively, writing to the HDD may be faster than writing to the SSD in certain situations. At 312, the RAID controller can signal the information handling system that the write is complete.

At 314, the RAID controller can receive a read request from the information handling system. The RAID controller can read the data from the SSD storage, as shown at 316. Typically, reading data from the SSD storage can be faster than reading data from the HDD storage, so performance can be improved by reading data from the SSD storage rather than the HDD storage. At 320, the RAID controller can provide the data from the SSD storage to the information handling system.

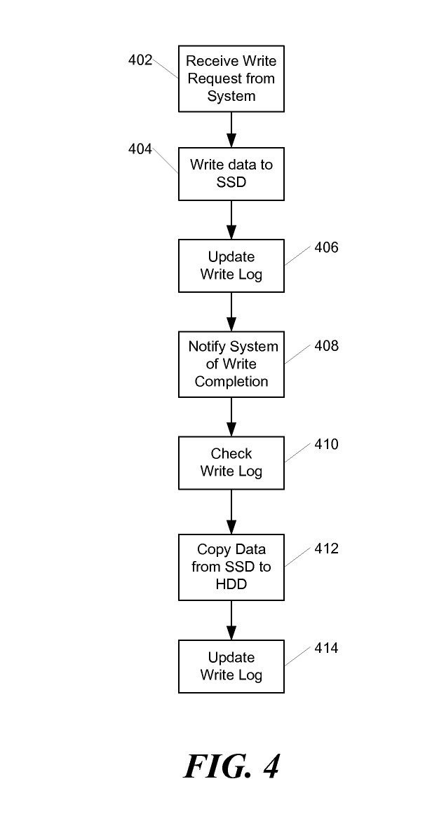

FIG. 4 shows an exemplary embodiment of a method for an asymmetric write to an asymmetric RAID device, such as RAID device 200. During an asymmetric write operation, the RAID device can first write data to the SSD storage and later copy the data to the HDD storage for redundancy. The RAID controller can maintain a list of data that needs to be copied from the SSD storage to the HDD storage to ensure data integrity. At 402, the RAID controller can receive the asymmetric write request from a system. At 404, the RAID controller can write the data to the SSD storage. Additionally, at 406, the RAID controller can update a write log to indicate that the write has not been performed on the HDD storage. The update to the write log at 406 can occur after the write to the SSD at 404 is complete. Alternatively, the update to the write log at 406 can occur before or during writing the data to the SSD at 404. At 408, the RAID controller can signal the information handling system that the asymmetric write is complete.

At 410, the RAID controller can check the write log to determine which data needs to be copied from the SSD to the HDD. At 412, the RAID controller can copy the data from the SSD storage to the HDD storage based on the write log. Writes to the HDD storage may be performed out of order based on the location within the HDD storage and the priority of the write. For example, a symmetric write to the HDD storage can have a higher priority than an asymmetric write, to improve overall system performance. The RAID controller can update the write log to indicate that the data has been copied from the SSD storage to the HDD storage, as shown at 414.

In an alternate embodiment, the RAID controller may begin to write the data to the HDD storage and to the SSD storage at substantially the same time. In said embodiment, the RAID controller can notify the information handling system that the write is complete when one storage device completes the write operation but prior to the other storage device completing the write operation. For example, writing to the SSD is typically faster and the RAID controller can signal the write operation is complete as soon as writing to the SSD is complete, but prior to the completion of writing to the HDD. Alternatively, the write to the HDD may complete first, and the RAID controller can signal the write operation is complete while waiting for the write to the SSD to complete.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system including an asymmetric RAID device, the information handling system comprising:
a RAID controller; and
a RAID volume including a first disk and a second disk attached to the RAID controller,
wherein the first disk provides faster access than the second disk.

2. The information handling system of claim 1, wherein the first disk comprises a solid state drive.

3. The information handling system of claim 1, wherein the second disk comprises a storage device having a component configured to move during normal operation.

4. The information handling system of claim 3, wherein the magnetic storage includes a hard disk drive.

5. The information handling system of claim 1, wherein the RAID controller is configured to receive an asymmetric write request, write data to the first disk, signal the asymmetric write request is complete, and copy the data from the first disk to the second disk after signaling the asymmetric write request is complete.

6. The information handling system of claim 5, wherein the RAID controller is further configured to maintain a write log indicating data to be copied to the second disk.

7. The information handling system of claim 1, wherein the RAID controller is configured to receive a read request, and read data from the first disk.

8. The information handling system of claim 1, wherein the RAID controller is configured to receive an asymmetric write request, write data to the first disk, write the data to the second disk, and signal the asymmetric request is complete prior to writing the data to the second disk.

9. The information handling system of claim 1, wherein the RAID controller is configured to receive a symmetric write request, write data to the first and second disks, and signal the symmetric write request is complete after writing data to the first and second disks.

10. A method of accessing an asymmetric RAID device for use with an information handling system, the method comprising:
receiving an asymmetric write request,
writing data to a first disk of a RAID volume;
signaling the asymmetric write request is complete; and
copying the data from the first disk of the RAID volume to a second disk of the RAID volume.

11. The method of claim 10, wherein the first disk includes a solid state drive.

12. The method of claim 10, wherein the second disk includes a storage device having a component configured to move during normal operation.

13. The method of claim 10, wherein the magnetic storage device includes a hard disk drive.

14. The method of claim 10, wherein copying the data is performed after signaling the asymmetric write request is complete.

15. The method of claim 10, further comprising receiving a read request and reading the data from the first disk of the RAID volume.

16. The method of claim 10, wherein the RAID controller is further configured to maintain a write log indicating data to be copied to the second disk.

17. An information handling system, the information handling system comprising:
a RAID volume including a solid state drive and a hard disk drive;
a RAID controller configured to
receive a write request;
write data to the solid state drive;
signal the write request is complete; and
copy the data from the solid state drive to the hard disk drive after signaling the request is complete.

18. The information handling system of claim 17, wherein the RAID controller is further configured receive a read request and read the data from the solid state drive.

19. The information handling system of claim 17, wherein the RAID controller is further configured to maintain a write log indicating data to be copied to the hard disk drive.
